(19) United States
(12) Patent Application Publication
(10) Pub. No.: US 2010/0171745 A1
(43) Pub. Date: Jul. 8, 2010

(54) MULTI VIEW VARIABILITY MODELING SYSTEM

(75) Inventor: Rabih Bachrouch, Belfast (GB)

Correspondence Address: IP GROUP OF DLA PIPER LLP (US), ONE LIBERTY PLACE, 1650 MARKET ST, SUITE 4900, PHILADELPHIA, PA, 19103, US

(73) Assignee: Queen's University of Belfast, Belfast (GB)

(21) Appl. No.: 12/349,797

(22) Filed: Jan. 7, 2009

(51) Int. Cl. G06T 11/20; G06T 11/00

(52) U.S. Cl. 345/441; 345/418

(57) ABSTRACT

Disclosed is a variability modeling system for product lines, and in particular software product lines. The system provides for a number of views, each view modeling features relevant to only a particular class of viewer. Said views may include a project management view, a behavioural view, a feature dependency and interaction view and a view intermediate between a convention feature model and an architectural model.

This invention relates to managing variability within product lines and in particular to variability modeling for software product lines.

Within Software Product Lines, features play an important role in specifying the fixed and variable parts of the architectures of product families and configurable systems. In its simplest form, a feature is an aspect of a system, such as a behavior or an attribute, from the end user's point of view.

Managing variability within the feature model is a key step for the success of a product family. Variability management is about managing the commonalities and variabilities within a product line. Commonalities are structured lists of assumptions that are true for all product members. Variabilities are structured lists of assumptions about how product members differ.

A classic example of variability is found in mobile phone product lines where variabilities include: the screen size, number of keys, language, etc. A Variation Point identifies a variability within the product line and its possible bindings by describing several variants. A variant is a possible way to realize or bind a variation point at a specified stage of the development process (design time, compilation time, run-time, etc.).

As variability is geared more towards software, and as more products are being included within a single product line, current complex systems tend to comprise a large number of variability points which makes traditional manual feature modeling techniques cumbersome and difficult to use.

Although current techniques provided many useful facilities for managing variability, a number of limitations are still exhibited. The ability to encompass and present a large number of variability points along with their relationships in one view remains a challenge. Attempts to alleviate this limitation by using different presentation techniques (e.g. three dimensional space, special purpose output devices and panels, etc.) have only had limited success and/or greatly increase hardware cost and complexity.

Consequently, it is an aim of the present invention to address some or all of the above-mentioned limitations.

In a first aspect of the invention there is provided a system for modeling variability within a product line wherein said system is operable to produce a model which is displayable in a plurality of views, each of said views modeling only some of the variability features modeled by the model as a whole, such that each of said views relates to a particular class of viewer.

Said product line may be a software product line.

One of said views may model variability aspects related to project management. Said variability aspects related to project management may include one, some or all of: feature implementation time, feature Cost/Benefit analysis, whether sets of features are allowed to be changed or not, negative features. Said view may be operable to display features differently depending on whether they are mandatory, optional or alternative. In each case said features may also be displayed differently dependent on whether they are allowed to be modified, or not.

One of said views may represent the way different features are organised and the behaviour attached to each feature. Said view may be presented as a hierarchal tree structure, ideally two-way. Said view may model behaviour using Use Case Maps (UCM) notation. Said view may be operable to model one or more of the following concerns, Feature behaviour, whether sets of features are allowed to be changed or not, negative features, feature implementation time, feature cardinality, variability binding time, alternative feature names.

One of said views may represent the dependency and interaction among features, whereby feature dependency is the effect that the presence or absence of one or more features has on the existence of other features, while feature interaction is the effect of feature combinations on system architecture. Said view may capture feature dependency and/or feature interaction using logic notation. Said logic notation may take the form of graphical logic gate notation or textual logic expressions.

One of said views may be a view intermediate between a conventional feature model and an architecture model. Said intermediate view may comprise a feature model incorporating one or more design decisions. Said design decisions may be chosen dependent on the architecture design approach used. In one embodiment, for example when the architecture design approach used is ADLARS, design decisions are incorporated by grouping features into those implemented concurrently, that is those which require a separate thread of execution each, and those which are functional. Features in said former group may be mapped to different tasks within a system architecture description and said latter group may map to components or sub-components within a system architecture description. Said intermediate view may include a further group of features, these being external features with which the system may be required to interact. Said external group of features may be classified in three ways, platform features, third party software and networking technologies. Said intermediate view, in one embodiment, may show feature interrelation in at least three ways comprising composition of features from other features, realization of features by other features and the variability of a feature to an external feature or other aspect of its environment. Said view may model one or more of the following concerns: design decisions: whether sets of features are allowed to be changed or not, negative features, feature cardinality, variability binding time.

Said system may comprise conventional computer hardware and display.

In a second aspect of the invention there is provided a system for modeling variability within a product line wherein said system is operable to produce a model which is displayable in a plurality of views, each of said views representing only some of the variability features modeled by the model as a whole, such that each of said views relates to a particular class of viewer; said views comprising:

a first view modeling variability aspects related to project management;

a second view modeling the way different features are organised and the behaviour attached to each feature; and

a third view modeling the dependency and interaction among features, whereby feature dependency is the effect that the presence or absence of one or more features has on the existence of other features, while feature interaction is the effect of feature combinations on system architecture.

Said product line may be a software product line.

Said system may further comprise a fourth view intermediate between a conventional feature model and an architecture model, incorporating one or more design decisions.

Optional features relating to each of the views in the first aspect are equally applicable to each of the views of this aspect.

In a further aspect of the invention there is provided a computer program stored on computer readable media, said computer program being such that, when loaded on a conventional computer with display, provides any of the systems of the first and second aspects of the invention.

### BRIEF DESCRIPTION OF THE DRAWINGS

Embodiments of the invention will now be described, by way of example only, by reference to the accompanying drawings.

FIG. 1 is a set diagram of the four views model and the concerns modelled in each view, in accordance with an embodiment of the invention.

FIG. 2 shows an example of the first view in accordance with an embodiment of the invention.

FIG. 3 shows an example of the second view (in part) in accordance with an embodiment of the invention.

FIG. 4 shows an example of the third view in accordance with an embodiment of the invention.

FIG. 5 shows an example of the fourth view (in part) in accordance with an embodiment of the invention.

### DETAILED DESCRIPTION OF THE EMBODIMENTS

There are many variability management requirements and concerns that the inventors have identified. These requirements are in the form of information and relationships that should be captured relating to features in a feature model. The Four Views Model (4VM) embodiment of the invention is built around these concerns. More concerns can be added to the list in the future to accommodate special application domain or enterprise requirements (e.g. feature evolution, etc.), while others are not strictly necessary and could be removed. Consequently, the following (non-exhaustive) list of concerns should be understood to be only an example.

Feature Dependency

Within real-life systems, features in a model affect each other in a number of ways. Some features cannot be supported unless other feature(s) are supported in a product (mutually dependent); other features cannot be supported in the same product at the same time (mutually exclusive).

For example, consider an automobile product family where: engine size (e.g. 1.1L, 2L, etc.), gearbox/transmission (e.g. Automatic, Manual—number of gears: 4,5,6 etc.), and body type (sport, sedan, station wagon, etc.) are among the features of the product family. The number of gears in a gearbox may be dependent on the engine size; so an engine size 1.1L and a 5-gear gearbox may be mutually exclusive (cannot coexist in the same product). Similarly, body type may be dependent on the engine size; such that a station wagon may require at least an engine size of 1.8L (mutually dependent).

Dependencies can be quite difficult to model, especially those that relate to quality attributes. Hence, dependencies should not only be represented as first class citizens in any feature model, but also the technique used for capturing dependencies should allow for complex dependency representation.

Feature Interaction

While the presence or absence of features within a feature model may affect the existence of other features (feature dependency), feature interaction is concerned with how different feature combinations affect the system architecture. Features are realized in an architecture using different components and configurations. Different feature combinations might lead to the inclusion of different architectural components and configurations.

For example, consider two optional features: FeatureA and FeatureB. Assume that, if FeatureA is supported by a product, it is realized in the architecture using Component1; similarly, if FeatureB is supported, it is realized in the architecture using Component2. Within a product that supports FeatureA, if supporting FeatureB means only the inclusion of Component2 in the product architecture, then these features are considered independent (do not interact). However, if supporting FeatureB (at the same time as FeatureA) means the inclusion of other components than Component1 and Component2 (and perhaps the exclusion of Component1 and/or Component2), then FeatureA and FeatureB are considered to be interacting features.

Predicting feature interaction in a system is a challenging task. Minimizing feature interaction is considered good practice as it reduces the architecture complexity when relating features to architectural structures. One way to minimize feature interaction is by restructuring the feature model and introducing new features to abstract those interactions (the concept of feature abstraction is discussed in more detail below).

Behavioral Features

Capturing behavior at the variability management level form a crucial part of the variability model. This is due to the fact that some variability requirements encompass behavioral information that could not be captured using traditional approaches. An example is when capturing information relating to messaging or communication protocols among different components within a system. Another example is capturing information relating to data flows and data paths.

Many approaches have been proposed to capture behavior, from using UML state charts and use case diagrams within multiple-views of the variability model; to embedding Use Case Maps scenarios within the variability model; and to maintaining separate behavioral models, e.g., separate interaction models and state chart models.

Variability Binding Time

Variation points are places in the design or implementation where variation occurs. Variability is due to unmade decisions that are left open as long as economically feasible. However, specifying the point in time when a variation point is to be bound to a specific variant is important.

A number of possible binding times have been identified and used in industry. Examples are:

Design time: where the decision about a variability point is made at the design stage. Beyond that point (e.g. implementation stage, run time, etc.), this variation point is not visible. An example of a design time binding is to allow for linking features to the inclusion/exclusion of architectural components as well as the reconfiguration of the architecture. This is design time variability and binding.

Implementation time: the variation point is not decided upon until implementation. For this binding time, variation points appear at the code level. A good example of implementation time variability with C/C++ is the use of pre-processor directives. In the compiled version of the system (the executable), variability points introduced using pre-processor directives are invisible.

Link time: this is when the variation point is not decided upon until linking time. An example of link time variability is MS Windows Dynamic Link Libraries (DLLs).

Load time: the variation point is not decided upon until the load of the system. Load time variability can be introduced using a number of mechanisms such as configuration files.

Run time: Depending on the application, this tends to be the most desirable binding time. This is when variation points are left open until the run time when the end user can make the decision on how to bind the variability. However, due to price (cost, effort, time to implement, etc.) and complexity (complexity of the system, size of code, etc.) this is not always a feasible option. There are numerous examples of run time variability where variation points are bound including, for example, using the application's “options” or “settings” menu.

Feature Implementation Time

In industry, software systems are usually built incrementally; there is rarely a software product that is built as a final release from the first edition. Products are usually enhanced and features added to them continuously over time. Planning for future releases of products, the features to be implemented in these products, and the timing, is a key step for the success and sustainability of a product line. Therefore, feature implementation time should also be captured within the feature model as it contributes to product versioning.

Cost/Benefit Analysis

The effort needed and cost involved in realizing features as well as their foreseen benefit should be documented in the feature model. This provides valuable input to the overall project costing and the product versioning process.

Although in general it is not an easy task to specify the cost/effort and benefit involved in realizing a given feature, adequate estimates can be obtained using information gathered and experiences gained from previous similar projects.

Open/Closed Sets of Features

Within industrial projects, it is rarely the case that the architect is furnished with the system's comprehensive and complete set of features. Rather, features are continuously added (and modified) to the initial feature model over time—even after the system design process has commenced.

Designing a system around an open and changing set of features that can be modified anytime is a very challenging task. To overcome this problem, some industries differentiate between two types of features: closed and open features.

Closed sets of features are sets of features that cannot be changed or modified by the architect or the development team and serve as the core of the product or product line. Modifying such features requires the approval of a management appointed committee or a designated authority which would analyze the impact and feasibility of any requested modification to such features.

On the other hand, open sets of features are those that tend to change over time (for example due to technology advance or the addition of new features) and are less likely to affect the overall system when altered. Such features can be modified and changed by the project manager, architect, or the development team depending on the nature of the feature. Such information should be clearly specified in the system feature model.

Negative Features

Naturally, the development of feature models has typically focused on the features that are to be supported by a product or product line. Little attention has been paid to features that are not to be supported by a given product (or a range of products). Limiting the features supported by different products within a product line supports the development of product ranges, for example, varying from low-end products (that support a minimum number of features) to high-end ones (with most/all of the features enabled).

Negative features are features that are specified not to be supported by a given product(s). If such negative features are specified, the product (or product line) architecture should be designed in a way to prohibit the enabling of such features by end users of the product.

If such features are not identified and counted for at a very early stage in the design process, they could lead to different kinds of problems based on the nature of the product line.

In more critical application domains, overlooking negative features could have more adverse effects.

Alternative Feature Names

Variability management exists at the different stages of the development life-cycle, from requirements, to architecture design and implementation. Different teams (e.g. stakeholders, architects, developers, etc.) use their own mechanisms to manage variability and to express features. So, it is possible that the same feature could be referred to by different names within different teams. Hence, it is important to keep track of the features and their alternative names within the feature model.

Feature Cardinality

It is always desirable to delay design decisions as much as is economically feasible (creating variation points). However, variation points come with a price (increased complexity of the system, performance degradation, increase in cost and marketing time, etc.). One potential solution to alleviate the effect of open variation points is by attaching a limited number of possible variants that could be bound to a given variation point. This is usually referred to as feature cardinality.

Multiple Users and Access Control.

As will be explained below, it is of an advantage to have more than one view for a variability management where each view would be targeted at a specific user group (stakeholders). Due to the integration of some business/managerial considerations within the variability model, it is useful that a variability management solution provides access control to the variability model data. This would insure that users can only see information relevant to their view and can only modify properties that are within their remit of authority.

In addition, in many cases, the variability model is developed concurrently by a number of users who would focus on different parts of the model. So, it is important that the variability management solution provide the proper mechanisms to allow for such parallel amendments of the model. This could be done in real-time by validating each command against the variability model before executing it. This way, the variability model is kept up-to-date at any point in time. Alternatively, it could be done off-line where different users develop their models independently; then, these models are merged to form a new model. The importance of merging variability models becomes more significant when there is the need for adding commercial off-the-shelf components (COTS) to the system. COTS components would have their own sub-model that would need to be merged with the existing system variability model.

Four Views Model for Variability Management (4VM)

All the above concerns are examples of the different types of concerns which may be taken into account when modeling variability. It has been recognised by the inventors that only some of these concerns will be relevant to particular stakeholders, while others will not. Consequently different stakeholders will be interested in viewing different aspects (views) of the product line variability model. Therefore, it is useful for a variability management mechanism to be able to extract and present relevant information about the family model in dedicated views for different groups of stakeholders (users, system analysts, developers, etc.). This could considerably contribute to alleviating the graphical overload when showing all the information in one view (compared to multiple views). This forms the basis of the 4VM model.

In this section, the Four Views Model for Variability Management (4VM) is introduced. The 4VM proposes a four view presentation of the feature model. The 4VM may address some or all of the issues and concepts identified above.

The views adopted in the 4VM model are:

Business View: where the information related to the project management, cost/benefit analysis, etc. is presented.

Hierarchical & Behavioral View: where the way the different features are organized (usually presented in a tree structure) along with the behavior attached to each feature is presented.

Dependency & Interaction View: where the dependency and interaction among features is presented.

Intermediate View: where some design decisions are injected into the feature model to take it one step further towards the architecture domain in an attempt to bridge the gap between the feature model and the system architecture.

The Business view is aimed at project and product managers. The intermediate view is aimed mainly for architects. The hierarchical view and dependency/interaction views are aimed at architects and developers.

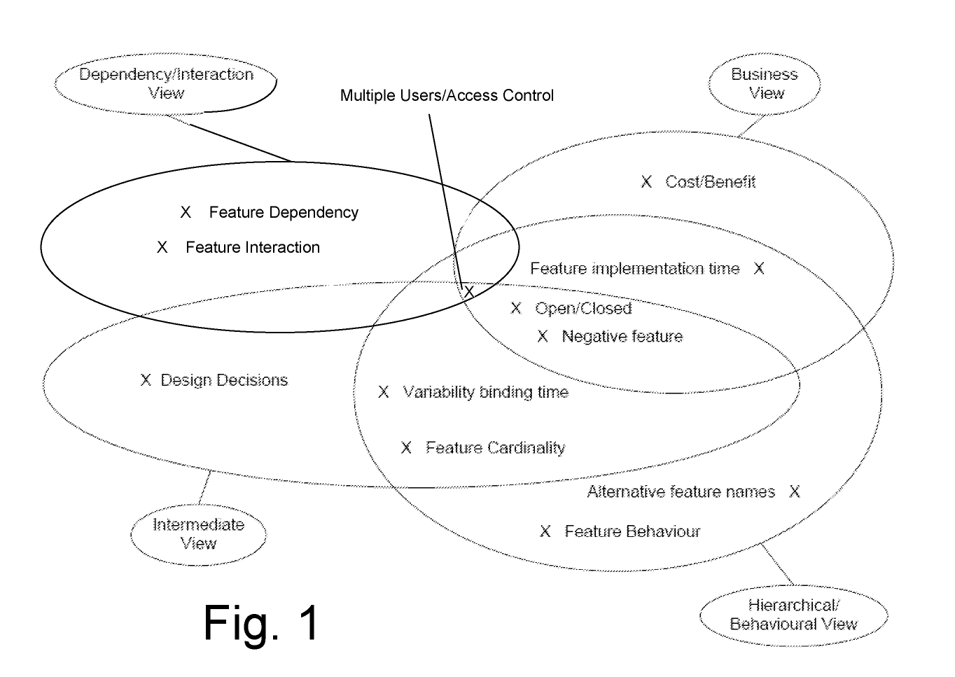

FIG. 1 shows a set diagram indicating which of the above views model which concern. Describing each of these views in turn:

Business View

The Business View is aimed at the project business and management stakeholders. It acts as a portal for inputting and presenting information related to (for example):

Feature implementation time

Feature Cost/Benefit analysis

Open/Closed sets of features

Negative features

These properties are usually specified and used by the project managers to carry out system-wide business analyses which support decision making such as when to introduce features within a product line; what features are feasible from a business perspective, etc.

FIG. 2 shows an example business view. In this example, a red circle indicates a mandatory feature while a green circle indicates an optional/alternative feature. A line across the circle (e.g. Effects, Packet Classifier, etc.) indicates a closed feature or feature set, that is one that cannot be deleted or modified by the architects/developers.

We could also see in the example above that the Effects feature (and sub-features) is marked as closed. This means that only a designated authority can modify this feature set (add new effects, modify existing properties, etc.). By right clicking over the feature, it is possible to change feature properties such as its cost, implementation time, etc. Also, the tool could allow for generation of project costing (based on the information contained within the feature model), feature introduction timeline (product versioning), etc.

Hierarchical & Behavioral View

The Hierarchical and Behavioral View is the view provided by most existing feature modeling techniques. In this view, information related to the structure of the feature model and the behavior of the features is captured. Among other potential users, this view is mainly targeted at architects and developers.

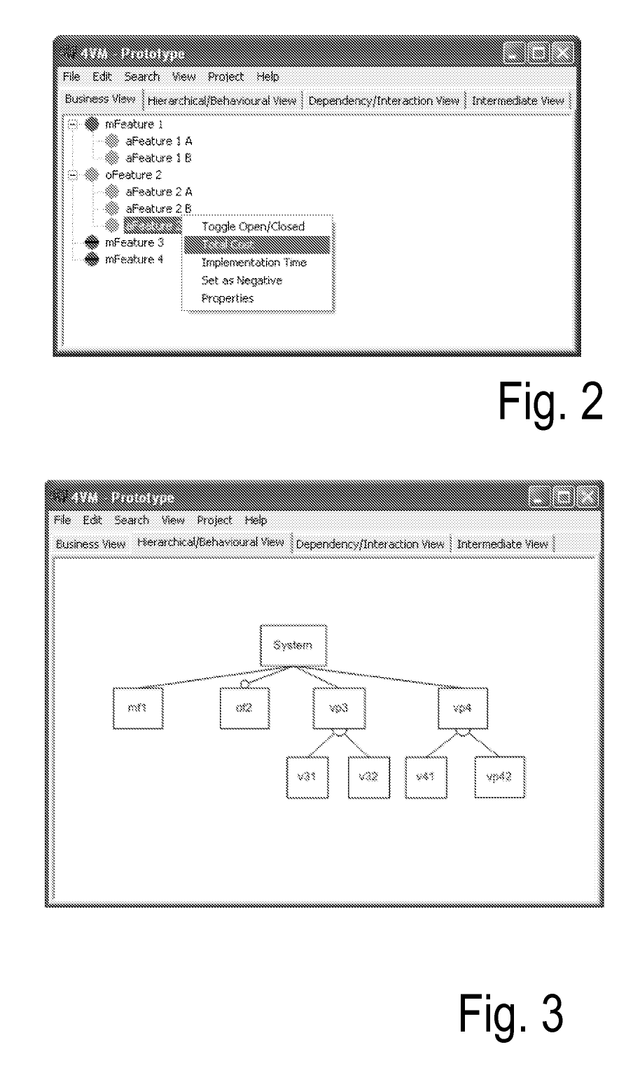

FIG. 3 below shows an example of what is typically presented within the Hierarchical and Behavioral view. In this embodiment, the Use Case Maps (UCM) notation is used to model feature behavior.

As this view is largely conventional, it will not be described further here.

Dependency and Interaction View

Due to the size and complexity of feature dependency and interaction within real-life systems, a separate view is created within the 4VM to model these relationships. The Dependency and Interaction View is complementary to the Hierarchical and Behavioral View.

In this model, feature dependency and feature interaction are defined as follows:

Feature Dependency: a feature-to-feature dependency where the inclusion of one or more features affects one or more features within the system.

Feature Interaction: a feature-to-architecture dependency where the inclusion of one or more features affects the architecture structure (different component sets and/or configurations, etc.).

In this view, logic design is proposed to capture the dependency and interaction relationships. Once the relationships are modeled, standard logic algorithms can be used to simplify the models.

The feature dependency model takes as input the user selected feature set and verifies it against the model pointing out any conflicts within the feature selection.

Once feature dependency is verified, the selected feature set is fed to the feature interaction model that outputs a new mutually exclusive set of features, with new features introduced to abstract feature interaction, which is a novel approach proposed to handle feature interaction.

Consider the “requires” relationship that exists between Modifying/encoding IP packets and Sending/Receiving IP packets. For a system to support Modifying and encoding of IP packets, it should be able to receive (and send) such packets in the first place. Assume that a new feature is to be added to the system to introduce the support for secure communication. Although secure communication (using IPSec) will not affect the sending and receiving of packets at the network level, it would require a change to the coding (encryption is added to the process) and decoding (decryption is added to the process) of IP packets. In this example, the feature dependency model captures the dependency of Modify/Encode IP feature on Send/Receive IP feature. This is done using an AND gate. If Send/Receive IP feature is not selected, Modify/Encode IP feature cannot be selected. The mapping of textual relationship description into logic circuits can be relatively straight forward where “not” maps to inverters, “and” to AND gate, and “or” to OR gate. With more complex expressions and relationships, existing logic methods and algorithms can be used at a later stage to simplify the overall model.

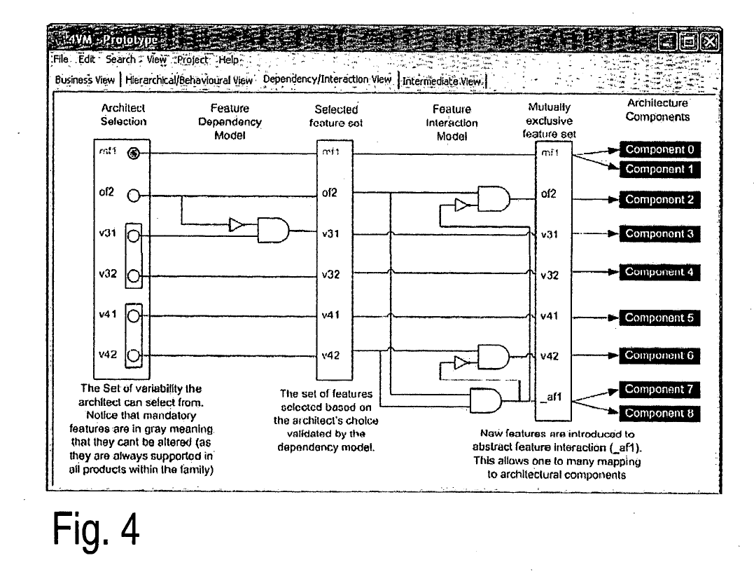

FIG. 4 below shows the dependency and interaction view for IP support. The first column to the left shows what options the architect has to choose from. An empty circle means an optional feature.

Once the architect makes his selection, the selection is validated against the dependency model and any conflict is reflected in the second column (the middle one). The architect could then go back and choose a different feature set to resolve the conflict.

Once a non-conflicting feature set is selected, it is then passed to the interaction model where interactions are resolved by introducing new abstract features. In the example above, the Modify/Encode IPSec feature was introduce to abstract the interaction between Modify/Encode IP feature and Secure Comm feature.

The advantage of resolving feature interaction at this stage is that it minimizes architecture complexity by making the relationship between the feature set and the architecture structure a one-to-many relationship rather than a many-to-many relationship. This is achieved by making the feature set a mutually independent set with the introduction of abstract features.

The graphical notation used in this example is for demonstration purposes. Logic gates can be replaced with other shapes that are friendlier to non-hardware architects. Also, textual logic expressions can be used instead of a graphical notation.

3.4. Intermediate View

Finally, the intermediate view has been introduced in an attempt to bridge the gap between feature modeling and the architecture design. This gap exists between the two domains due to the fact that the feature model is based on end-user and stakeholder concerns while the architecture structure is designed to accommodate technical concerns.

To bridge this gap, the intermediate view attempts at injecting design decisions into the feature model to take it one step further towards the architecture domain. As such, it may be regarded as an intermediate stage between feature model and system architecture.

The structure of the intermediate view and the selection of the design decisions to be injected in the feature model to create the intermediate view depend heavily on the architecture design approach used. For example, ADLARS was used as the Architecture Description Language (ADL) for the architecture design and description [see R. Bashroush et al, “ADLARS: An Architecture Description Language for Software Product Lines.” In proceedings of the 29th Annual IEEE/NASA Software Engineering Workshop, Greenbelt, Maryland, USA, April 2005. pp. 163-173, which is incorporated herein by reference].

ADLARS partitions the space into three dimensions: Concurrency (captured within Tasks), Structure and Functionality (captured within Components) and Behavior (Captured by Interaction Themes). Therefore, the feature model would be much easier to map to architecture structures if it shows what features are to be implemented concurrently and what features are mere functionality. By injecting such design decisions in the feature model, we end up with the intermediate view which is easier to follow at the architecture design process.

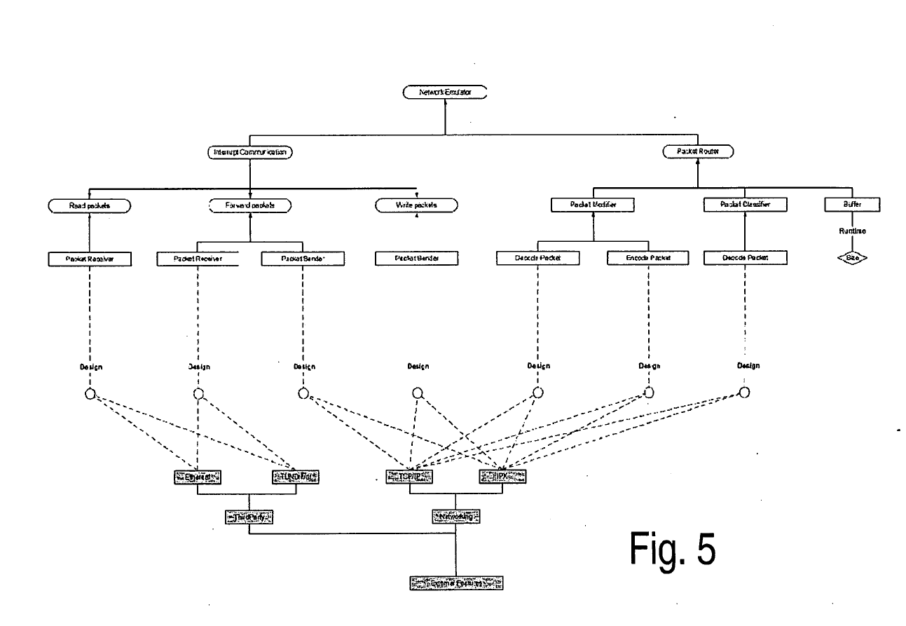

FIG. 5 shows a small part of the intermediate view. It shows three types of features:

Concurrency features: (rounded boxes) which are features that require a separate thread of execution each. These map to different ADLARS tasks within the system architecture description.

Functionality features: (unshaded boxes) which are features that describe system functionality (usually as a part of a specific thread of execution). These map to ADLARS components and sub-components within the system architecture description.

External features: (shaded boxes) these are features that are external to the system or product family (over which we have no control) and with which the system would need to interact. These are classified in three types: Platform: related to the platform the system is running on (RTOS, Unix, Win32, etc.), third party software: e.g. TUNDrive, a piece of third party software that provides user applications with a virtual Ethernet network interface card over Unix based systems (the one used in the network emulator case study) and networking technologies: e.g. TCP/IP, IPX, etc. in case our system needs to communicate over the network (which is the case for the network emulator).

Also, to better identify with ADLARS (where Tasks are composed of Components, etc.), the features within the intermediate view are related in three ways:

Composition: which is represented by a bottom up arrow and means that a given feature is composed of the features below it. For example, the “Forward Packets” feature is composed of two features, “Packet Receiver” and “Packet Sender”.

Realization: which is represented by a top down arrow and means that a given feature is realized or deployed by the features below it, that is, the parent feature is a template feature implemented by one of the children features. For example, the “Interrupt Communication” feature could either be: “Read Packets”, “Write Packets” or “Forward Packets”.

Environment: which relates the variability of a feature to an external feature (environment). For example, the “Packet Sender” feature is related to what network protocol is used (e.g. TCP/IP, IPX, etc.) which is an environment feature.

It is worth mentioning here that the intermediate view model developed and described herein is designed to work best within an architecture process that starts with feature modeling and uses ADLARS for architecture design and description. For other design approaches and ADLs, appropriate intermediate views can be developed accordingly.

The foregoing example is for illustrative purposes only, and it should be understood that other embodiments and variations are envisaged without departing from the spirit and scope of the invention. For example the actual concerns and aspects modelled in each view may vary from those shown, and may include other aspects and concerns not mentioned herein, or omit aspects and concerns described above, or group them differently. It should also be noted that each of the views in themselves, in particular business view, dependency and interaction view and intermediate view are novel.

What is claimed is:

1. A system for modeling variability within a product line wherein said system is operable to produce a model which is displayable in a plurality of views, each of said views modeling only some of the variability features modeled by the model as a whole, such that each of said views relates to a particular class of viewer.

2. A system as claimed in claim 1 wherein said product line is a software product line.

3. A system as claimed in claim 1 wherein one of said views models variability aspects related to project management.

4. A system as claimed in claim 3 wherein said variability aspects related to project management include one, some or all of: feature implementation time, feature Cost/Benefit analysis, whether sets of features are allowed to be changed or not and negative features.

5. A system as claimed in claim 3 wherein said view is operable to display features differently depending on whether they are mandatory, optional or alternative.

6. A system as claimed in claim 3 wherein said view is operable to display features differently dependent on whether they are allowed to be modified, or not.

7. A system as claimed in claim 1 wherein one of said views is operable to represent the way different features are organised and the behavior attached to each feature.

8. A system as claimed in claim 7 wherein said view is presented as a hierarchal tree structure.

9. A system as claimed in claim 7 wherein said view models behaviour using Use Case Maps (UCM) notation.

10. A system as claimed in claim 7 wherein Said view is operable to model one or more of the following concerns, Feature behaviour, whether sets of features are allowed to be changed or not, negative features, feature implementation time, feature cardinality, variability binding time and alternative feature names.

11. A system as claimed in claim 1 wherein one of said views is operable to represent the dependency and interaction among features, whereby feature dependency is the effect that the presence or absence of one or more features has on the existence of other features, while feature interaction is the effect of feature combinations on system architecture.

12. A system as claimed in claim 11 wherein said view is operable to capture feature dependency and/or feature interaction using logic notation.

13. A system as claimed in claim 12 wherein said logic notation takes the form of graphical logic gate notation or textual logic expressions.

14. A system as claimed in claim 1 wherein one of said views comprises a view intermediate between a conventional feature model and an architecture model.

15. A system as claimed in claim 14 wherein said intermediate view comprises a feature model incorporating one or more design decisions.

16. A system as claimed in claim 15 wherein said system is operable such that the way in which said design decisions are incorporated is dependent on the architecture design approach used.

17. A system as claimed in claim 16 wherein the architecture design approach used is ADLARS, and wherein said system is a arranged such that said design decisions are incorporated by grouping features into those implemented concurrently, that is those which require a separate thread of execution each, and those which are functional.

18. A system as claimed in claim 17 wherein features implemented concurrently are mapped to different tasks within a system architecture description, and said functional features map to components or sub-components within a system architecture description.

19. A system as claimed in claim 17 wherein said intermediate view includes a further group of features, these being external features with which the system may be required to interact.

20. A system as claimed in claim 19 wherein said external group of features are classified in three ways, platform features, third party software and networking technologies.

21. A system as claimed in claim 14 wherein said intermediate view is operable to show feature interrelation in at least three ways comprising: composition of features from other features, realization of features by other features and the variability of a feature to an external feature or other aspect of its environment.

22. A system as claimed in claim 14 wherein said view is operable to model one or more of the following concerns: design decisions: whether sets of features are allowed to be changed or not, negative features, feature cardinality and variability binding time.

23. A system as claimed in claim 1 wherein said system comprises conventional computer hardware and display.

24. A system for modeling variability within a product line wherein said system is operable to produce a model which is displayable in a plurality of views, each of said views representing only some of the variability features modeled by the model as a whole; said views comprising:
a first view modeling variability aspects related to project management;
a second view modeling the way different features are organised and the behaviour attached to each feature; and
a third view modeling the dependency and interaction among features, whereby feature dependency is the effect that the presence or absence of one or more features has on the existence of other features, while feature interaction is the effect of feature combinations on system architecture.

25. A system as claimed in claim 24 wherein said product line is a software product line.

26. A system as claimed in claim 24 wherein said variability aspects related to project management include one, some or all of: feature implementation time, feature Cost/Benefit analysis, whether sets of features are allowed to be changed or not and negative features.

27. A system as claimed in claim 24 wherein said first view is operable to display features differently depending on whether they are mandatory, optional or alternative.

28. A system as claimed in claim 24 wherein said first view is operable to display features differently dependent on whether they are allowed to be modified, or not.

29. A system as claimed in claim 24 wherein said second view is presented as a hierarchal tree structure.

30. A system as claimed in claim 29 wherein said second view models behaviour using Use Case Maps (UCM) notation.

31. A system as claimed in claim 24 wherein said second view is operable to model one or more of the following concerns, Feature behaviour, whether sets of features are allowed to be changed or not, negative features, feature implementation time, feature cardinality, variability binding time and alternative feature names.

32. A system as claimed in claim 24 wherein said third view is operable to capture feature dependency and/or feature interaction using logic notation.

33. A system as claimed in claim 32 wherein said logic notation takes the form of graphical logic gate notation or textual logic expressions.

34. A system as claimed in claim 24 further comprising a fourth view intermediate between a conventional feature model and an architecture model, incorporating one or more design decisions.

35. A system as claimed in claim 34 wherein said system is operable such that the way in which said design decisions are incorporated is dependent on the architecture design approach used.

36. A system as claimed in claim 35 wherein the architecture design approach used is ADLARS, and wherein said system is a arranged such that said design decisions are incorporated by grouping features into those implemented concurrently, that is those which require a separate thread of execution each, and those which are functional.

37. A system as claimed in claim 36 wherein features implemented concurrently are mapped to different tasks within a system architecture description, and said functional features map to components or sub-components within a system architecture description.

38. A system as claimed in claim 36 wherein said fourth view includes a further group of features, these being external features with which the system may be required to interact.

39. A system as claimed in claim 38 wherein said external group of features are classified in three ways, platform features, third party software and networking technologies.

40. A system as claimed in claim 34 wherein said fourth view is operable to show feature interrelation in at least three ways comprising: composition of features from other features, realization of features by other features and the variability of a feature to an external feature or other aspect of its environment.

41. A system as claimed in claim 34 wherein said fourth view is operable to model one or more of the following concerns: design decisions: whether sets of features are allowed to be changed or not, negative features, feature cardinality and variability binding time.

42. A system as claimed in claim 1 wherein said system comprises conventional computer hardware and display.

43. A computer program stored on computer readable media, said computer program being operable such that, when loaded on a conventional computer with display, provides the system of claim 1.

44. A computer program stored on computer readable media, said computer program being operable such that, when loaded on a conventional computer with display, provides the system of claim 24.

45. A computer program stored on computer readable media, said computer program being operable such that, when loaded on a conventional computer with display, provides the system of claim 34.
